(19) United States
(12) Patent Application Publication
(10) Pub. No.: US 2009/0273460 A1
(43) Pub. Date: Nov. 5, 2009

(54) Pneumatic tyre for vehicle wheels provided with an antenna and method of manufacturing thereof

(76) Inventors: Federico Mancosu, Milano (IT); Massimo Brusarosco, Milano (IT); Anna Paola Fioravanti, Milano (IT); Guido Luigi Daghini, Milano (IT); Renato Caretta, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/666,689

(22) PCT Filed: Nov. 5, 2004
(86) PCT No.: PCT/IT2004/000608

§ 371 Date: Dec. 3, 2008

(51) Int. Cl. B60C 23/00

(52) U.S. Cl. 340/445

(57) ABSTRACT

A pneumatic tyre for vehicle wheels with a radially inner surface of a substantially toroidal conformation, includes at least one antenna provided with an electrically conductive elongated body in engagement with the radially inner surface through a plurality of constraint elements. Each pair of consecutive constraint elements identifies an orthodromic distance smaller than the length of the elongated-body portion between this pair of elements. Also described is a method of setting the antenna on the inner surface of the tyre.

The present invention relates to a pneumatic tyre for vehicle wheels, of the type provided with an antenna to enable transmission and/or reception of operating parameters of the tyre itself, for example.

The present invention also relates to a method of manufacturing said tyre.

On some vehicle typologies the necessity is felt to monitor the operating conditions of the tyres in real time and to keep a trace of the evolution in time of the parameters representative of said operation. In particular in the case of vehicles using tyres of the “run flat” type, i.e. tyres capable of ensuring travelling over some kilometric distance even in case of tyre deflation, provided some operating parameters are met such as maximum speed, temperature and maximum distance that can be traveled over, the above requirement becomes of the greatest importance for safe use of said type of tyres.

For instance, the parameters that are generally taken into account can be temperature, pressure, distance traveled over by the tyre, as well as parameters resulting from mathematical calculations that can be carried out within the tyre.

For the purpose, a transponder system can be mounted within the tyre, which system may comprise at least one sensor, a control unit and/or a data storage unit (such as a microprocessor) and an antenna; the antenna's task is to enable exchange of radiofrequency signals with the devices mounted onboard the vehicle.

In addition, the antenna can allow powering of the system present within the tyre without using a self-contained supply unit (e.g. batteries within the tyre). Therefore it is provided for the apparatus mounted onboard the vehicle to generate an electromagnetic field with which the antenna placed in the tyre can be coupled and from which said antenna can receive the necessary energy to be transmitted to the control unit and the sensor.

US 2004/0032377 discloses a tyre on the inner surface of which an antenna is mounted, together with the required circuitry for achieving a transponder system. The antenna and the other circuit elements are fastened to the tyre during manufacture of the tyre itself, so that connection between antenna and inner surface of the tyre is continuous along the circumferential extension of the tyre itself.

EP 1 384 603 A1 shows a system in which antenna and transponder are at least partly housed in a ring of non conductive rigid material, said ring being in engagement with the inner surface of the tyre.

The Applicant has verified that the above described systems are unable to ensure a reliable constraint between the antenna and inner surface of the tyre and can cause damages to both of them during operation of the tyre, which damages can even lead to breaking of the antenna itself.

The tyre in fact, during use, is submitted to elastic deformations in the order of 3-5% in each of the three space directions; the antenna that is generally made of a metallic material, cannot withstand these deformations due to its lower intrinsic elasticity as compared with that of the tyre.

Therefore, following stresses to which the tyre is submitted, the antenna may break at one or more points thus preventing operation of the transreceiving system.

The Applicant has ascertained that this drawback is mainly due to the substantially continuous constraint proposed by known systems for application of the antenna to the tyre. In fact, a constraint of this nature, as it is obtained between a flexible body, i.e. the tyre, and a substantially rigid body, i.e. the antenna, causes the different forces acting on the tyre to be directly transmitted to the antenna, giving rise to the above mentioned faults or malfunctions.

The Applicant has therefore perceived that, in order to ensure the system integrity even in case of deformations to which the tyre is submitted under use conditions, it is necessary to make the antenna remain substantially decoupled from the forces transmitted by the tyre during running, while being always mechanically coupled with the tyre itself. Therefore the antenna must adapt itself to the tyre deformations through variation of its geometric arrangement rather than through elongation.

In more detail, the antenna is engaged with the radially inner surface of the tyre by discrete constraint elements so that each pair of constraint elements identifies an orthodromic distance smaller than the length of the antenna portion included between said pair of elements.

In this context by, “orthodromic distance” it is intended the minimum distance between two points on a toroidal surface.

In this way, this length is sufficient to enable adaptation thereof to the tyre deformations, i.e. the antenna is substantially decoupled from the mechanical stresses transmitted from the tyre. Thus the antenna is prevented from being submitted to stresses capable of impairing its integrity at one or more points.

In particular, in a first aspect the present invention relates to a tyre for vehicle wheels having a radially inner surface of a substantially toroidal conformation, comprising: at least one antenna provided with an electrically conductive elongated body in engagement with said radially inner surface through a plurality of constraint elements, wherein each pair of consecutive constraint elements identifies an orthodromic distance smaller than the length of the elongated-body portion included between said pair of elements.

In a further aspect the present invention relates to a method of setting at least one antenna on a radially inner surface of a tyre of substantially toroidal conformation, said method comprising the following steps: setting at least one electrically conductive elongated body; fastening said elongated body to said inner surface at a plurality of constraint elements, so that each pair of consecutive constraint elements identifies an orthodromic distance smaller than the length of the elongated-body portion included between said pair of elements.

Further features and advantages will become more apparent from the detailed description of a preferred but not exclusive embodiment of a tyre for vehicle wheels, and of a method of setting at least one antenna on a radially inner surface of said tyre, in accordance with the present invention.

This description will be set out hereinafter with reference to the accompanying drawings, given by way of non-limiting example, in which:

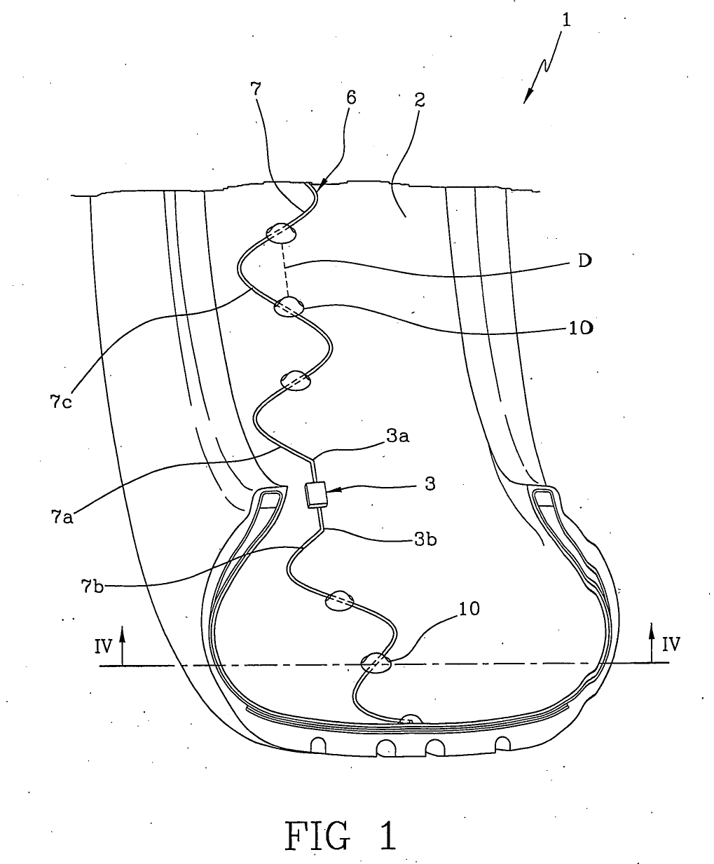

FIG. 1 is a partial perspective view of a tyre in accordance with the invention;

FIG. 1b is a partial perspective view of an inner surface of the tyre in accordance with the invention;

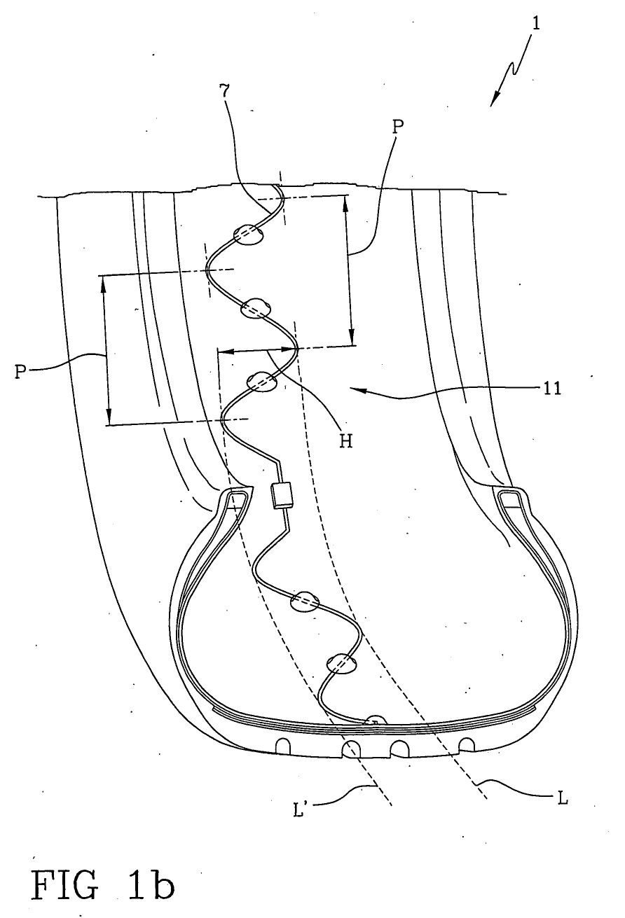

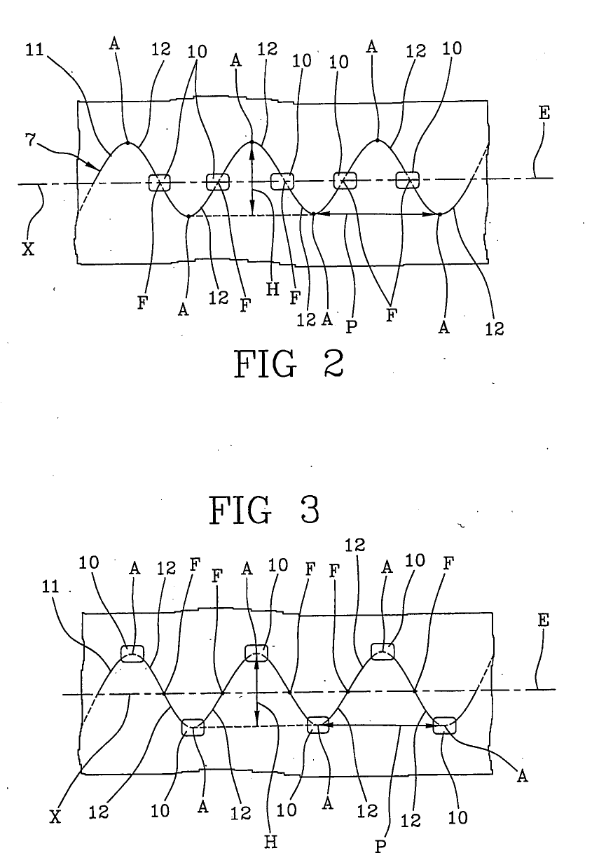

FIGS. 2 and 3 diagrammatically show planar extensions of an inner surface of the tyre in FIG. 1;

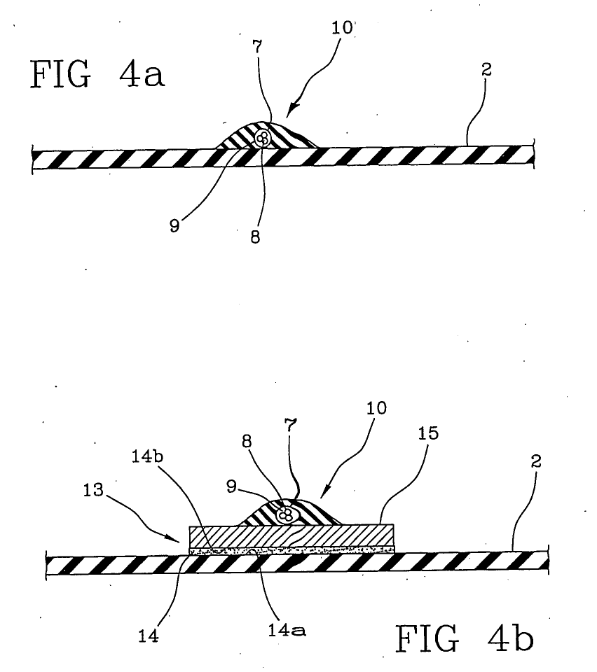

FIG. 4a is a partial section along line IV-IV of a first embodiment of the tyre seen in FIG. 1;

FIG. 4b is a partial section along line IV-IV of a second embodiment of the tyre seen in FIG. 1;

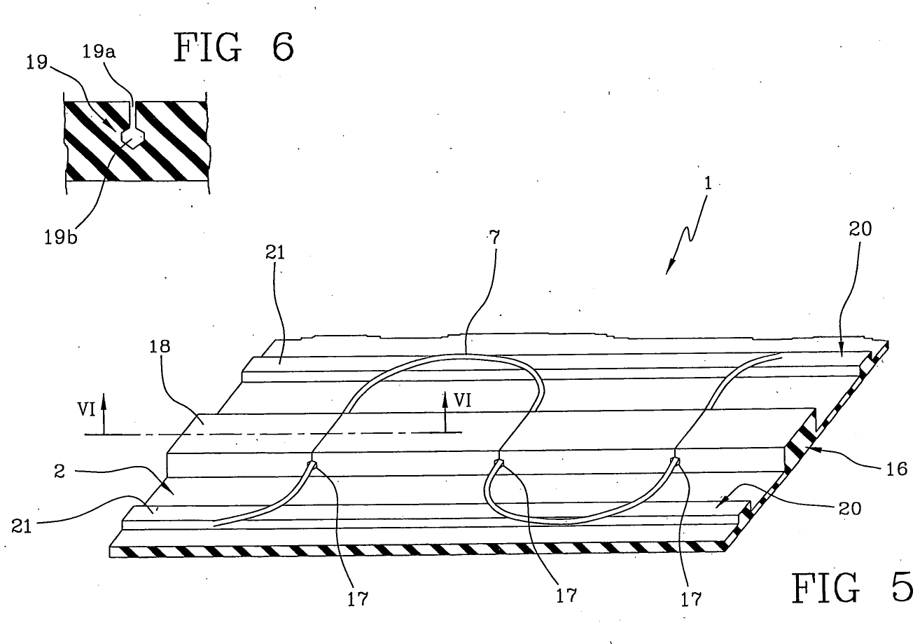

FIG. 5 is a partial perspective view of a further embodiment of the tyre seen in FIG. 1;

FIG. 6 is a partial section view taken along line VI-VI of a detail seen in FIG. 5;

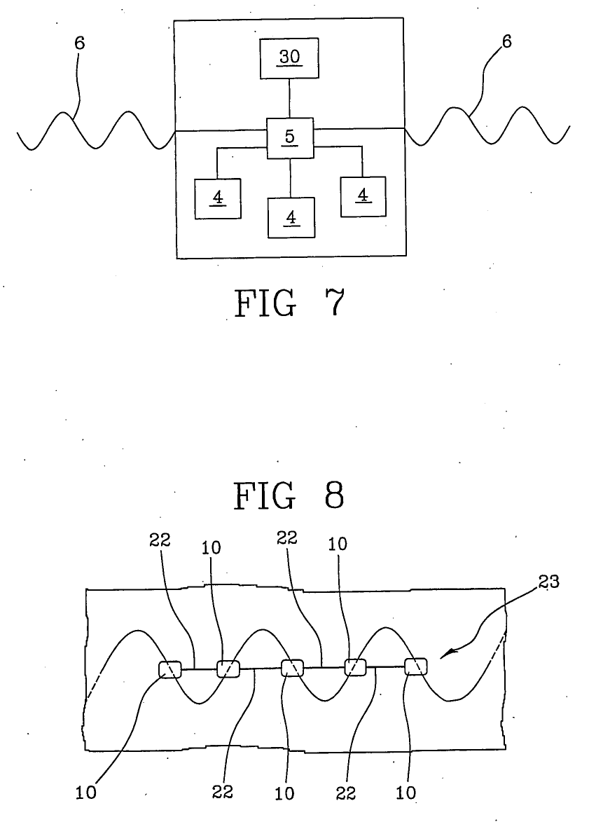

FIG. 7 is a block diagram of a device being part of the tyre in FIG. 1;

FIG. 8 is a plan view of an operating element used in the method of the invention.

With reference to the drawings, a tyre for vehicle wheels in accordance with the invention has been generally identified with reference numeral 1.

Tyre 1 can be mounted on any type of vehicles such as motor-vehicles or motorcycles; in more detail, tyre 1 is set to be used on vehicles that onboard are provided with the electronics necessary to co-operate and interact with the devices that are housed in the tyre itself and that will be described in the following.

Tyre 1 has a radially inner surface 2 of substantially toroidal conformation; this inner surface can be defined by a layer of elastomer material currently referred to as “liner”.

Mounted on said radially inner surface 2 is a control unit 3 set to detect and/or store, and/or process operating parameters relating to tyre 1 and to the operating conditions of the latter.

The control unit 3 (diagrammatically shown in FIG. 7) may comprise one or more sensors 4 for detecting said operating parameters; said parameters can be tyre temperature, inner tyre pressure, and/or distance traveled over possibly calculated in co-operation with the devices located onboard.

The control unit 3, is further provided with a microprocessor 5 connected with said sensors 4 for operation control; also associated with microprocessor 5 is a memory 30 to store data detected by sensors 4.

Also stored in memory 30 can be data identifying tyre 1, so that the latter can be univocally recognised during processing and evaluation of the above mentioned operating parameters.

It is to be pointed out that in a different embodiment, when only reading of data identifying tyre 1 and/or the possibility of storing further data concerning the same is of interest, the control unit 3 may comprise the only memory 30 controlled by microprocessor 5.

Preferably, microprocessor 5 is set to talk to an electronic device positioned onboard the vehicle on a wheel of which tyre 1 is mounted.

To enable communication between microprocessor 5 and the electronic device placed onboard, an antenna 6 is provided to be operatively associated with the control unit 3 and, in particular, microprocessor 5.

Antenna 6 is preferably mounted on the radially inner surface 2 of tyre 1.

In addition to the above, antenna 6 can be also used to power the control unit 3 and the devices contained therein, so that use of self-governed power supply units within tyre 1 is avoided.

For the purpose, antenna 6 has a loop conformation (or more exactly a conformation of the “closed” type as defined in the following), so that it can be coupled with an electromagnetic field generated by the device present onboard the vehicle and absorb the energy required for power supply of the control unit 3.

Data exchange between microprocessor 5 and said electronic device takes place through transmission and reception of radiofrequency signals (RF signals), the frequency of which may be included between about 100 kHz and about 50 MHz, and preferably can correspond to about 125 kHz. In particular this frequency range can be used if the control unit 3 is wished to be fed by the antenna 6 itself which in this case will have a configuration of the “closed” type. On the contrary, if antenna 6 is preferably used for data transmission/reception, also frequencies included between about 300 mHz and about 2.5 GHz may be contemplated and in this case antennas with a configuration of the “open” type are used.

In the present context and in the appended claims, by antenna of the “open” type it is intended an antenna the conformation of which defines an electrically open circuit. For example, the antenna body can have one or more ends connected with the control unit 3 and one or more “free” ends.

By the expression antenna of the “closed” type it is intended an antenna the conformation of which defines an electrically closed circuit.

The co-operation between the onboard devices, antenna 6 and control unit 3 therefore constitutes a transponder system enabling the control unit 3 to operate also in the absence of batteries or similar powering units mounted within tyre 1.

Antenna 6 (FIG. 1) is provided with an electrically-conductive elongated body 7 in engagement with the inner surface 2 of tyre 1 through a plurality of constraint elements 10; more particularly, the elongated body 7 comprises at least one electric conductor 8 and at least one protective coating 9 for the electric conductor (FIGS. 4a, 4b). Preferably the protective coating 9 is made of an elastomer material and has a specific electric resistance in accordance with UNI 4288 standard included between about 100 ohm/meter and about 10⁹ ohm/meter.

The protective coating 9, as better clarified in the following, enables the effects of the direct contact between the more flexible radially inner surface 2 of tyre 2 (the liner's surface, for example) and the elongated body 7 of a more rigid metallic material to be reduced, which contact can cause wear, local abrasions, cuts.

In this way, the protective coating 9 reduces to the minimum the possibility that the antenna 6 by its oscillation during normal use of tyre 1, may damage the radially inner surface 2 of said tyre in an important manner.

In a first preferred embodiment, the electric conductor 8 is a cord manufactured following the 7×3 scheme, i.e. a cord made up of 7 strands each formed of 3 brass-coated steel wires or copper wires, each of said wires having a diameter included between about 0.1 mm and about 0.2 mm. Preferably, in order to reduce the overall impedance of antenna 6, for the three wires of the central strand (that are less stressed) use of copper is preferred, whereas for the other wires of the remaining 6 strands, steel is used.

For an antenna 6 having an elongated body 7 as long as about 2.5 m, if wires of a diameter of 0.15 mm are used, the impedance is of about 2.1 ohm if the wires are made of brass-coated steel; if copper wires are used, the impedance is of about 0.21 ohm; if 6 strands of brass-coated steel and one (the central strand) of copper are used, the impedance is of about 1.5 ohm.

In a further alternative embodiment, the electric conductor 8 can be a cord manufactured following the 3×3 scheme, i.e. having the same structure as above described but comprising 3 strands instead of 7 with a diameter for the wires included between about 0.1 mm and about 0.2 mm; in this case, with use of brass-coated steel wires of a diameter of about 0.12 mm, an antenna 6 having an impedance of about 7 ohm is obtained.

In another embodiment, the electric conductor 8 can consist of a cord manufactured following the hybrid 2+2 scheme, in which 2 wires of brass-coated steel wound upon themselves are twisted with 2 aluminium wires wound upon themselves; the diameter of each wire is included between about 0.2 mm and about 0.3 mm, and the impedance of antenna ˜6 with use of wires with a diameter of about 0.25 mm is about 3 ohm.

Generally, antenna 6 has an impedance included between about 0.02 ohm and about 10 ohm, and more particularly an impedance included between about 0.02 ohm and about 5 ohm; preferably, the impedance value of antenna 6 can be of about 1 ohm.

Generally, the elongated body 7 of antenna 6 has a first end 7a operatively associated with a first end 3a of the control unit 3, and a second end 7b operatively associated with a second end 3b of the control unit 3; depending on requirements and the features of the transponder system used, antenna 6 can be both of the open or the closed type.

As above mentioned, the elongated body 7 is in engagement with the radially inner surface 2 of tyre 1 through a plurality of constraint elements 10; this engagement is made in such a manner that each pair of consecutive constraint elements 10 identifies an orthodromic distance D smaller than the length of portion 7c of the elongated body 7 included between said pair of elements 10 and measured along the extension of the elongated body 7 itself.

In other words, the elongated body 7 is mounted in such a manner that it is disposed in a circumferential conformation (rectilinear in a plane extension) between consecutive constraint elements 10, but it is left suitably free to move in the presence of the different stresses so that it can adapt itself to the variations in the mutual distance between said constraint elements 10 due to the deformations to which the radially inner surface 2 of tyre 1 is submitted in use, in particular but not only at the footprint area.

In this way antenna 6 while remaining mechanically coupled with tyre 1, is substantially decoupled from the forces transmitted therefrom during running; in fact antenna 6 adapts itself to the tyre 1 deformations through variations in its geometrical arrangement in the lengths concerned with said deformations, without being subjected to stresses capable of impairing integrity of same.

The Applicant has observed that the above described behaviour is of the greatest importance during use of run flat tyres (i.e. tyres provided with reinforcing inserts at the sidewalls enabling running under deflated conditions too) when at least one of said tyres is deflated, i.e. during a flat running of one of them. In fact, the inventive tyre 1 transmits to the antenna, the forces due to ground contact in a negligible manner, said forces being much greater than those acting during running under normal inner-pressure conditions. In this way even during the most severe tyre conditions it is always possible for the driver to “read” the tyre state and thus improve the vehicle's safety conditions.

The elongated body 7 preferably has an undulated longitudinal extension 11 defined by a succession of waves, each extending between two axially spaced ends. By joining said axially spaced ends to each other in the region close to one tyre sidewall by orthodromic lines and by joining said axially spaced ends to each other in the region close to the opposite tyre sidewall, two lines are obtained that are defined “end lines” L, L′ (FIG. 1b).

In the present specification and the appended claims, by pitch “P” of each wave it is intended the segment of the same end line included between two axially spaced subsequent ends.

In the present specification and the appended claims, by height “H” of each wave it is intended the orthodromic distance between one of said axially spaced ends and the end line opposite thereto.

In a preferred embodiment, said undulated longitudinal extension 11 has a substantially sinusoidal configuration where each end line is coincident with the line joining the points of maximum and with the line joining the points of minimum respectively, wherein pitch P of each wave is coincident with the orthodromic distance between two subsequent points of maximum or minimum and the height H is coincident with the distance between a point of maximum and the stretch (rectilinear in a plane extension) defining pitch P relating to that wave.

In this preferred embodiment each wave can be divided into two semi-waves 12, each having opposite concavity with respect to the adjacent semi-waves (FIGS. 2-3).

Therefore, each semi-wave 12 is included between two consecutive inflection points F, each of which identifies the change of concavity between a semi-wave 12 and the preceding or following semi-wave.

The inflection points F of the undulated extension 11 having a substantially sinusoidal configuration follow each other on the inner surface 2 of tyre 1 along a line preferably substantially disposed in an equatorial plane E of tyre 1 that from now on will be denoted as “longitudinal axis” X of the undulated extension 11.

Preferably, the ratio between the wave pitch P and the wave height H of the undulated extension 11 of the elongated body 7 is included between about 1 and about 5.

More particularly, this ratio is included between about 4/3 and about 4, and in a preferred embodiment this ratio is substantially equal to about 10/3.

Practically, the wave pitch P of the undulated extension 11 in a substantially sinusoidal configuration (FIGS. 2 and 3) can be of about 100 mm for example, with a height H of about 30 mm; with a tyre having an extension of the equatorial line as long as about 2 metres, about 40 constraint elements can be used and the length of the elongated body is of about 2510 mm.

The constraint elements 10 used for fastening antenna 6 to the inner surface 2 can be positioned at the maximum or minimum points “A” of the sinusoidal configuration of the undulated-extension 11 (FIG. 3).

Alternatively, or in addition to the above, the constraint elements 10 can be located at the inflection points F of said sinusoidal configuration in the undulated extension 11 of the elongated body 7 (FIG. 2).

In the last-mentioned case, the constraint elements 10 are preferably substantially positioned in the equatorial plane E of tyre 1. In addition, said constraint elements 10 can be disposed in any convenient manner adapted to ensure both adhesion of antenna 2 to the radially inner surface of tyre 1 and said substantial decoupling between the forces acting on the tyre and those transmitted to the antenna.

In a first embodiment (FIG. 4a), the constraint elements 10 consist of plates of silicone-based sealing elastomer material enabling direct and substantially elastic fastening of the elongated body 7 to the radially inner surface 2 of tyre 1.

This material has good mechanical features and excellent adhesion properties for bonding to the inner surface 2.

In a second embodiment (FIG. 4b) each constraint element 10 is provided with a coupling insert 13 comprising at least one adhesive element 14; this adhesive element has the task of fastening the elongated body 7 to the radially inner surface of tyre 1.

Preferably, the adhesive element 14 can be made as a two-sided adhesive tape having a first adhesive surface 14a that is brought into contact with the inner surface 2 of tyre 1 and a second adhesive surface 14b to which the elongated body 7 is fastened.

Advantageously, each coupling insert 13 further comprises an elastomer layer 15 interposed between the elongated body 7 and said adhesive element 14.

The elastomer layer 15, at each constraint element 10, can consist of a rubber plate having a hardness included between about 300 Shore A and about 700 Shore A (measured at 25° C.) and a specific electric resistance in accordance with UNI 4288 standard included between about 100 ohm/meter and about 10⁹ ohm/meter.

The elongated body 7 can be fastened to the constraint elements 10 by means of said silicone-based sealing elastomer material or by different materials which in any case are provided with sufficient elasticity and flexibility once they are set up, to ensure adhesion between elements and decoupling between forces as presently illustrated.

Preferably, during manufacturing of tyre 1, the elongated body 7 is engaged to the constraint elements 10 before positioning the constraint elements 10 on the radially inner surface 2 of tyre 1.

In particular, it is provided that a succession 23 of constraint elements 10 be set (FIG. 8), each being preferably made as above described; each constraint element 10 being in engagement with the adjacent constraint elements through a provisional constraint 22.

This provisional constraint 22 can be obtained by means of a thin cotton thread for example that can be easily removed at the end of the manufacturing process.

Subsequently, the elongated body 7 is brought into engagement with the constraint elements 10 of said succession 23; the distance between each pair of adjacent constraint elements 10, in the case of sinusoidal extension of the elongated body 7, can define the wave half pitch P/2 (FIG. 2) of the undulated extension 11 of the elongated body 7.

In a subsequent step, through the adhesive elements 14, the succession 23 of the constraint elements 10 is fastened to the radially inner surface 2 of tyre 1.

Consequently, the elongated body 7 too is in engagement with the inner surface 2 of tyre 1. Finally, each provisional constraint 22 between adjacent constraint elements 10 can be removed; in this way, after defining the mutual position of the constraint elements 10 during the step of fastening the latter to the inner surface 2, these constraint elements 10 are no longer mutually tied and therefore can follow the displacements determined by the deformations to which tyre 1 is submitted during its use.

In a further embodiment, the radially inner surface 2 of tyre 1 has a radially inner ridge 16 that is provided with a plurality of engagement seats 17. Each engagement seat 17 shown in detail in FIGS. 5 and 6, defines a corresponding constraint element 10.

In a preferred embodiment each engagement seat 17 is spaced away from the adjacent seats by a stretch equal to the wave half pitch P/2 (FIG. 5) in the undulated extension 11 of a substantially sinusoidal configuration of the elongated body 7.

Preferably, the radially inner ridge 16 is defined by a circumferentially continuous main rib 18 on the inner surface 2 of tyre 1, the longitudinal symmetry axis of said main rib 18 being substantially contained in the equatorial plane E of tyre 1.

The engagement seats 17 can be obtained by making suitable cavities 19 in the main rib 18; advantageously, each cavity 19 has an inlet portion 19a and a housing portion 19b.

The inlet portion 19a is preferably defined by a cut formed in a transverse direction to the longitudinal extension of the main rib 18; this cut has a smaller width than the diameter of the elongated body 7 to enable a forced fitting into the engagement seat 17.

The housing portion 19b is at a radially external position relative to the inlet portion 19a and has the task of housing the elongated body 7 in a manner adapted to obtain mutual engagement between the elongated body 7 and the main rib 18.

Advantageously, after insertion of the elongated body 7 in said engagement seats 17 it is provided that one or more of said seats together with the elongated body portion housed therein, should be covered with at least one layer of adhesive material, a silicone-based covering and sealing material for example, having good flexibility features. In this way the constraint existing between the elongated body 7 and the radially inner surface 2 of tyre 1 is made more reliable and stronger.

Preferably tyre 1 further comprises one or more support ridges 20 located on the radially inner surface 2 of tyre 1.

The support ridges 20 enable the portions of the elongated body 7 that are not housed in said engagement seats 17 to rest thereon at least partly, so as to prevent said portions from being submitted to oscillations of great importance during use of tyre 1, at the risk of impairing the integrity of tyre 1 and/or antenna 6.

In a preferred embodiment, the support ridges 20 can comprise a pair of circumferentially continuous auxiliary ribs 21 positioned in planes substantially parallel to the equatorial plane E of tyre 1.

Preferably, the auxiliary ribs 21 are positioned on opposite sides of, and preferably spaced apart the same distance from said main rib 18 and they offer a rest to the outermost portions of the elongated body 7.

In a further preferred embodiment, the main rib 18 and possibly the auxiliary ribs 21 are superposed over an auxiliary layer (not shown) disposed radially external to said ribs 18, 21, directly in contact with the radially inner surface of tyre 1.

Said auxiliary layer, having protective functions with respect to the radially inner surface of tyre 1, can be made of elastomer material or other material compatible with the tyre structure. Preferably the auxiliary layer has a width in an axial direction included between about 60 mm and about 100 mm and a thickness in a radial direction included between about 0.1 mm and about 0.3 mm.

It is to be noted that the main rib 18, auxiliary ribs 21 and auxiliary layer can all be made directly on tyre 1 during the manufacturing process of same; alternatively, ribs 18, 21 and/or the auxiliary layer can be made separately and fastened to the inner surface 2 of tyre 1, through gluing for example, at the end of the manufacturing process of tyre 1.

1-43. (canceled)

44. A tyre for vehicle wheels having a radially inner surface of a substantially toroidal conformation, comprising:
at least one antenna provided with an electrically conductive elongated body in engagement with said radially inner surface through a plurality of constraint elements, wherein each pair of consecutive constraint elements identifies an orthodromic distance smaller than the length of the elongated-body portion between said pair of elements.

45. The tyre as claimed in claim 44, wherein said elongated body comprises:
at least one electric conductor; and
at least one protective coating for said electric conductor.

46. The tyre as claimed in claim 45 wherein said protective coating is made of a material having a specific electric resistance in accordance with UNI 4288 standard of about 100 ohm/meter and to about 10⁹ ohm/meter.

47. The tyre as claimed in claim 45, wherein said electric conductor comprises a cord made up of seven strands, each strand being formed of three wires.

48. The tyre as claimed in claim 47, wherein a central strand is made up of copper wires and the remaining six strands are made up of brass-coated steel wires.

49. The tyre as claimed in claim 45, wherein said electric conductor comprises a cord made up of three strands each formed of three wires.

50. The tyre as claimed in claim 45, wherein said electric conductor comprises a cord made up of two brass-coated steel wires wound upon themselves and twisted with two aluminium wires wound upon themselves.

51. The tyre as claimed in claim 44, wherein said elongated body in engagement with said radially inner surface of the tyre has an undulated extension.

52. The tyre as claimed in claim 51, wherein said undulated extension has a wave height and a wave pitch, the ratio between said pitch and said height being about 1 to about 5.

53. The tyre as claimed in claim 52, wherein said ratio is about 4/3 to about 4.

54. The tyre as claimed in claim 51 wherein said undulated extension is a sinusoidal extension.

55. The tyre as claimed in claim 44, wherein said constraint elements are located at inflection points of said elongated body.

56. The tyre as claimed in claim 51, wherein said constraint elements are located at the axially spaced ends of the undulated extension of said elongated body.

57. The tyre as claimed in claim 44, wherein said constraint elements are substantially positioned in the equatorial plane of said tyre.

58. The tyre as claimed in claim 44, further comprising a control unit to receive and/or transmit identification parameters of said tyre through said antenna.

59. The tyre as claimed in claim 44, further comprising a control unit to receive and/or transmit operating parameters of said tyre through said antenna.

60. The tyre as claimed in claim 59, wherein said control unit is mounted on the radially inner surface of said tyre and has a first and a second ends, said elongated body having a first end operatively associated with the first end of said control unit and a second end operatively associated with the second end of said control unit.

61. The tyre as claimed in claim 44, wherein said antenna has an impedance of about 0.02 ohm to about 10 ohm.

62. The tyre as claimed in claim 61, wherein said antenna has an impedance of about 0.02 ohm to about 5 ohm.

63. The tyre as claimed in claim 44, wherein each of said constraint elements comprises a coupling insert provided with at least one adhesive element interposed between said elongated body and said inner surface.

64. The tyre as claimed in claim 63, wherein each of said coupling inserts further comprises an elastomer layer interposed between said adhesive element and said elongated body.

65. The tyre as claimed in claim 44, wherein the radially inner surface of said tyre has at least one radially inner ridge for mutual engagement between said elongated body and said tyre.

66. The tyre as claimed in claim 65, wherein said at least one ridge is provided with one or more engagement seats, each defining said constraint element between said elongated body and the radially inner surface of said tyre.

67. The tyre as claimed in claim 65, wherein said ridge is defined by a main rib that is circumferentially continuous on the radially inner surface of said tyre and is substantially positioned in the equatorial plane thereof.

68. The tyre as claimed in claim 65, further comprising one or more support ridges on the radially inner surface of the tyre on which said elongated body rests.

69. The tyre as claimed in claim 68, wherein said one or more support ridges comprise a pair of circumferentially continuous auxiliary ribs positioned in planes parallel to the equatorial plane of said tyre on opposite sides relative to said main rib.

70. The tyre as claimed in claim 65, wherein said tyre comprises an auxiliary layer radially external to said radially inner ridge.

71. The tyre as claimed in claim 70, wherein said auxiliary layer has an axial width of about 60 mm to about 100 mm, and a radial thickness of about 0.1 mm and about 0.3 mm.

72. The tyre as claimed in claim 44, wherein the antenna is of the open type.

73. The tyre as claimed in claim 44, wherein the antenna is of the closed type.

74. A method of setting at least one antenna on a radially inner surface of a tyre of substantially toroidal conformation, said method comprising the following steps:
setting at least one electrically conductive elongated body; and
fastening said elongated body to said inner surface at a plurality of constraint elements, so that each pair of consecutive constraint elements identifies an orthodromic distance smaller than the length of the elongated-body portion between said pair of elements.

75. The method as claimed in claim 74, wherein the step of fastening said elongated body to said radially inner surface comprises the following steps:
positioning said constraint elements on the radially inner surface of the tyre; and
bringing said elongated body into engagement with each of said constraint elements.

76. The method as claimed in claim 75, wherein the step of positioning said constraint elements comprises a step of interposing an adhesive element between said elongated body and said radially inner surface.

77. The method as claimed in claim 76, wherein the step of positioning said constraint element comprises a step of disposing a layer of elastomer material between said adhesive element and said elongated body.

78. The method as claimed in claim 74, wherein said constraint elements are fastened to the radially inner surface of the tyre substantially at the equatorial plane thereof.

79. The method as claimed in claim 76, wherein a step of engaging said elongated body with said constraint elements is carried out before positioning said constraint elements on said radially inner surface.

80. The method as claimed in claim 75, wherein the step of fastening said elongated body to said inner surface further comprises:
setting a succession of constraint elements, each in engagement with the adjacent constraint elements through a provisional constraint;
bringing said elongated body into engagement with said constraint elements;
bringing said constraint elements into engagement with said inner surface; and
removing said provisional constraint.

81. The method as claimed in claim 74, wherein the step of fastening said elongated body to said radially inner surface comprises:
setting at least one radially inner ridge on said radially inner surface; and
forming at least one engagement seat in said at least one ridge, each seat defining a respective constraint element between said elongated body and said radially inner surface.

82. The method as claimed in claim 81, wherein said step of fastening said elongated body to said radially inner surface comprises the steps of:
engaging said elongated body in said at least one engagement seat; and
covering said at least one engagement seat and said elongated body engaged therein with at least one layer of adhesive material.

83. The method as claimed in claim 81, wherein the step of forming said at least one ridge comprises a step of making a circumferentially continuous main rib on said radially inner surface, the longitudinal symmetry axis of said main rib being substantially contained in the equatorial plane of the tyre.

84. The method as claimed in claim 81, further comprising a step of making at least one support ridge on which said elongated body rests.

85. The method as claimed in claim 84, wherein the step of making said at least one support ridge comprises a step of making a pair of circumferentially continuous auxiliary ribs on said radially inner surface, which auxiliary ribs are positioned in planes parallel to the equatorial plane of said tyre on opposite sides relative to said main rib.

86. The method as claimed in claim 81, wherein the step of setting at least one radially inner ridge on said radially inner surface is carried out after a step of setting an auxiliary layer at a radially inner position to said radially inner surface of the tyre.
